(19) United States
(12) Patent Application Publication
(10) Pub. No.: US 2013/0144008 A1
(43) Pub. Date: Jun. 6, 2013

(54) POLYURETHANE DISPERSANTS DERIVED FROM ALKOXY AROMATIC DIOLS

(71) Applicants: C. Chad Roberts, Hockessin, DE (US); Patrick F. McIntyre, West Chester, PA (US)

(72) Inventors: C. Chad Roberts, Hockessin, DE (US); Patrick F. McIntyre, West Chester, PA (US)

(73) Assignee: E I DU PONT DE NEMOURS AND COMPANY, Wilmington, DE (US)

(21) Appl. No.: 13/816,961

(22) PCT Filed: Sep. 1, 2011
(86) PCT No.: PCT/US11/50128

§ 371 Date: Feb. 14, 2013

Related U.S. Application Data
(60) Provisional application No. 61/379,050, filed on Sep. 1, 2010.

(51) Int. Cl. C09D 11/00

(52) U.S. Cl. CPC C09D 11/30
USPC 524/591

(57) ABSTRACT

The present invention relates to polyurethane dispersants based on alkoxy aromatic diols. These polyurethane dispersants are used to disperse pigments and/or disperse dyes and inks containing pigments and/or disperse dyes dispersed with these polyurethane ionic dispersants. The polyurethane dispersants can have nonionic hydrophilic substituents.

### CROSS-REFERENCE TO RELATED APPLICATION

This application claims priority under 35 U.S.C. §119 from U.S. Provisional Application Ser. No. 61/379,050, filed Sep. 1, 2011.

### FIELD OF THE INVENTION

The present invention relates to polyurethane dispersants based on alkoxy aromatic diols. These polyurethanes dispersants are effective for dispersion of particles, especially pigments. Pigments dispersed with the polyurethane dispersants can be used in ink jet inks.

### BACKGROUND OF THE INVENTION

Disclosed herein are polyurethane dispersants which can be used to make novel, stable aqueous particle dispersions. The polyurethane dispersants are especially useful for aqueous pigment dispersions. Also described is the process for making the pigment dispersions and the use thereof in ink jet inks.

Polyurethane polymers, for the purposes of the present invention are polymers derived from the reaction of isocyanate and isocyanate reactive compounds. The isocyanate reactive compounds include 1) diols substituted with ionic groups to aid in the dispersion of the polyurethanes and 2) compounds which have hydroxyl groups substituted on an aromatic compound or substituted on an aromatic group with an intervening alkyl or similar intervening group.

Polyurethanes can be used as ink additives for ink jet inks and as such are added at the ink formulation stage. But they can also be used as dispersants for pigments.

Polyurethane dispersions that are used as pigment dispersants have been described in U.S. Pat. No. 6,133,890. These polyurethanes are prepared with an excess of isocyanate reactive group and are limited to the presence of polyalkylene oxide components. WO2009/076381 describes polyurethane dispersants based on diols and polyether diols but the diols do not have a hydroxyl/alkoxy aromatic substitution pattern. Aqueous polyurethane dispersants have found limited use as dispersants for pigments and the like.

Therefore, there is still a need for a new class of polyurethane dispersants that can stably disperse particles, especially pigment particles in aqueous medium. The pigment particles dispersed with polyurethane dispersants are especially suited for use in aqueous inkjet inks.

### SUMMARY OF THE INVENTION

An embodiment of the invention provides a new class of polyurethane dispersants which are derived from alkoxy aromatic diols that produce stable aqueous dispersions of pigments. When these pigment dispersions are utilized for ink jet inks, images printed with the ink display both improved optical density and durability.

A further embodiment provides an aqueous pigment dispersion comprising an aqueous vehicle, a pigment and a first polyurethane dispersant, wherein

(a) the first first polyurethane dispersant physically adsorbs to the pigment,

(b) the first polyurethane dispersant stably disperses the pigment in the aqueous vehicle,

(c) the first polyurethane dispersant comprises an alkoxy aromatic diol, a diol substituted with an ionic group, and isocyanate,

wherein the alkoxy aromatic diol is Z₁

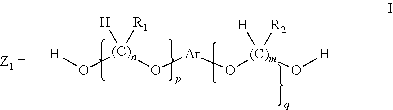

wherein Ar is an aromatic group,
n, m, p, and q are integers,
n, m are the same or different and are greater than or equal to 2 to 12,
p is greater than or equal to 1 to 15,
q is greater than or equal to 0 to 15,
R₁, R₂ are the same or different and each is independently selected from the group consisting of hydrogen, methyl, ethyl and higher alkyls of the formula of CₜH₂ₜ₊₁; where t is an integer and is greater than or equal to 3 to 36,
Z₂ is a diol substituted with an ionic group; and
at least one Z₁ and at least one Z₂ must be present in the first polyurethane dispersant composition; and
wherein the average pigment size of the aqueous pigment dispersion is less than about 300 nm.

A further embodiment provides an aqueous pigment dispersion comprising an aqueous vehicle, a pigment and a second polyurethane dispersant, wherein

(a) the second polyurethane dispersant physically adsorbs to the pigment,

(b) the second polyurethane dispersant stably disperses the pigment in the aqueous vehicle,

(c) the second polyurethane dispersant comprises an alkoxy aromatic diol, a diol substituted with an ionic group, and isocyanate,

wherein the alkoxy aromatic diol is Z₁

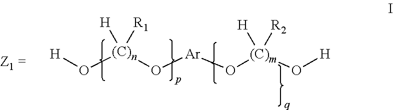

wherein Ar is an aromatic group,
n, m, p, and q are integers,
n, m are the same or different and are greater than or equal to 2 to 12,
p is greater than or equal to 1 to 15,
q is greater than or equal to 0 to 15,
R₁, R₂ are the same or different and each is independently selected from the group consisting of hydrogen, methyl, ethyl and higher alkyls of the formula of CₜH₂ₜ₊₁; where t is an integer and is greater than or equal to 3 to 36,
Z₂ is a diol substituted with an ionic group; and
at least one Z₁ and at least one Z₂ must be present in the second polyurethane dispersant composition; and wherein
the second polyurethane dispersant has at least one compound of the structure (II)

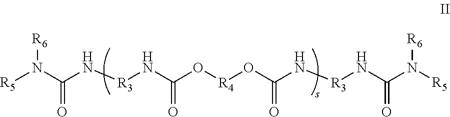

R₃ is alkyl, substituted alkyl, substituted alkyl/aryl from diisocyanate;

R₄ is Z₁ or Z₂,

R₅ is hydrogen; alkyl; branched alkyl or substituted alkyl from the amine terminating group,

R₆ is alkyl, branched alkyl or substituted alkyl from the amine terminating group,

s is an integer greater than or equal to 2 to 30;
and wherein the average pigment size of the aqueous pigment dispersion is less than about 300 nm.

Yet another embodiment provides an aqueous colored ink jet ink comprising the aqueous pigment dispersion having from about 0.1 to about 10 wt % pigment based on the total weight of the ink, a weight ratio of the pigment to the first or second polyurethane dispersant of from about 0.5 to about 6, a surface tension in the range of about 20 dyne/cm to about 70 dyne/cm at 25° C., and a viscosity of lower than about 30 cP at 25° C.

Another embodiment provides the ink sets in comprising at least three differently colored inks (such as CMY), and optionally at least four differently colored inks (such as CMYK), wherein at least one of the inks is an aqueous inkjet ink comprising the pigment dispersed with the first or second polyurethane dispersant described above.

When a black ink is included in the CMYK ink set the black ink can be a self-dispersed black pigment.

The other inks of the ink set are preferably also aqueous inks, and may contain dyes, pigments or combinations thereof as the pigment. Such other inks are, in a general sense, well known to those of ordinary skill in the art.

In another aspect, the disclosure provides a method of ink jet printing onto a substrate comprising, in any workable order, the steps of:

(a) providing an ink jet printer that is responsive to digital data signals;

(b) loading the printer with a substrate to be printed;

(c) loading the printer with an aqueous ink jet ink comprising an aqueous ink vehicle, a pigment dispersed with the first or second polyurethane dispersant described above;

(d) printing onto the substrate using the aqueous ink jet ink, in response to the digital data signals to form a printed image on the substrate.

In yet another aspect, the disclosure provides a method of ink jet printing onto a substrate comprising, in any workable order, the steps of:

(a) providing an ink jet printer that is responsive to digital data signals;

(b) loading the printer with a substrate to be printed;

(c) loading the printer with an aqueous inkjet ink set where at least one of the inks in the ink set comprises an aqueous ink vehicle, a pigment dispersed with the first or second polyurethane dispersant described above

(d) printing onto the substrate using the aqueous ink jet ink, in response to the digital data signals to form a printed image on the substrate.

These and other features and advantages of the present invention will be more readily understood by those of ordinary skill in the art from a reading of the following Detailed Description.

Certain features of the invention which are, for clarity, described above and below as separate embodiments, may also be provided in combination in a single embodiment. Conversely, various features of the invention that are described in the context of a single embodiment may also be provided separately or in any subcombination.

### DETAILED DESCRIPTION

Unless otherwise stated or defined, all technical and scientific terms used herein have commonly understood meanings by one of ordinary skill in the art to which this invention pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

As used herein, “comprising” is to be interpreted as specifying the presence of the stated features, integers, steps, or components as referred to, but does not preclude the presence or addition of one or more features, integers, steps, or components, or groups thereof. Additionally, the term “comprising” is intended to include examples encompassed by the terms “consisting essentially of” and “consisting of:” Similarly, the term “consisting essentially of” is intended to include examples encompassed by the term “consisting of:”

When the term “about” is used in describing a value or an end-point of a range, the disclosure should be understood to include the specific value or end-point referred to.

As used herein, reference to enhanced or improved “print quality” means some aspect of optical density of the printed images and fastness (resistance to ink removal from the printed image) is increased, including, for example, rub fastness (finger rub), water fastness (water drop) and smear fastness (highlighter pen stroke).

As used herein, the term “binder” means a film forming ingredient in an inkjet ink.

As used herein, the term “Gardner color” means a visual scale and was originally developed to describe colors of commercial chemical products. A lower number Gardner scale reading indicates a lighter color.

As used herein, the term “self-dispersed pigment” means a self-dispersible” or “self-dispersing” pigments.

As used herein, the term “dispersion” means a two phase system where one phase consists of finely divided particles (often in the colloidal size range) distributed throughout a bulk substance, the particles being the dispersed or internal phase and the bulk substance the continuous or external phase.

As used herein, the term “dispersant” means a surface active agent added to a suspending medium to promote uniform and maximum separation of extremely fine solid particles often of colloidal size. For pigments the dispersants are most often polymeric dispersants and usually the dispersants and pigments are combined using dispersing equipment.

As used herein, the term “nonionic” means a substructure of a compound which has repeating —CH₂CH(R)O— groups that impart nonionic character to the compound; these groups can be incorporated into polymeric dispersants.

As used herein, the term “OD” means optical density.

As used herein, the term “CMY” means the colorants cyan, magenta and yellow; K can be

As used herein, the term “aqueous vehicle” refers to water or a mixture of water and at least one water-soluble organic solvent (co-solvent).

As used herein, the term “aromatic” means a cyclic hydrocarbon containing one or more rings typified by benzene which has a 6 carbon ring containing three double bonds. Aromatic includes cyclic hydrocarbons such as naphthalene and similar multiple ring aromatic compounds.

As used herein, the term “alkyl” means a paraffinic hydrocarbon group which may be derived from an alkane and the formula is Cₙ H₂ₙ₊₁. A substituted alkyl may have any substitution including hetero atoms substitutions such as carboxyl, amine hydroxyl.

As used herein, the term “ionizable groups” means potentially ionic groups.

As used herein, the term “AN” means acid number, mg KOH/gram of solid polymer.

As used herein, the term ““neutralizing agents” means to embrace all types of agents that are useful for converting ionizable groups to the more hydrophilic ionic (salt) groups.

As used herein, the term “substantially” means being of considerable degree, almost all.

As used herein, the term “Mn” means number average molecular weight.

As used herein, the term “Mw” means weight average molecular weight.

As used herein, the term “PD” means the polydispersity which is the weight average molecular weight divided by the number average molecular weight.

As used herein, the term “d50” means the particle size at which 50% of the particles are smaller; “d95” means the particle size at which 95% of the particles are smaller.

As used herein, the term “cP” means centipoise, a viscosity unit.

As used herein, the term “prepolymer” means the polymer that is an intermediate in a polymerization process, and can be also be considered a polymer.

As used herein, the term “PUD” means the polyurethanes dispersions described herein.

As used herein, the term “DBTL” means dibutyltin dilaurate.

As used herein, the term “DMPA” means dimethylol propionic acid.

As used herein, the term “EDTA” means ethylenediaminetetraacetic acid.

As used herein, the term “HDI” means 1,6-hexamethylene diisocyanate.

As used herein, the term “GPC” means gel permeation chromatography.

As used herein, the term “IPDI” means isophorone diisocyanate.

As used herein, the term “TMDI” means trimethylhexamethylene diisocyanate.

As used herein, the term “TMXDI” means m-tetramethylene xylylene diisocyanate.

As used herein the term T650 means TERATHANE® 650.

As used herein, the term “NMP” means n-Methyl pyrrolidone.

As used herein, the term “TEA” means triethylamine.

As used herein, the term “THF” means tetrahydrofuran.

As used herein, the term “Tetraglyme” means Tetraethylene glycol dimethyl ether.

TERATHANE 650 is a 650 molecular weight, polytetramethylene ether glycol (PTMEG) commercially available from Invista, Wichita, Kans.

TERATHANE 250 is a 250 molecular weight, polytetramethylene ether glycol.

Jeffamine M-600 is a methoxyethyl terminated 600 molecular weight poly(propylene oxide/ethylene oxide) monoamine with PO/EO ratio of 9/1.

Unless otherwise noted, the above chemicals were obtained from Aldrich (Milwaukee, Wis.) or other similar suppliers of laboratory chemicals.

The materials, methods, and examples herein are illustrative only and, except as explicitly stated, are not intended to be limiting.

The use of polymeric conventional dispersants is well established as a means to make stable dispersions of particles, especially pigment particles. In general, these conventional dispersants have, at least, modest water solubility and this water solubility is used as a guide to predicting dispersion stability. These dispersants are most often based on acrylate/acrylic compounds. During diligent searching for new, improved polymeric dispersants, a new class of dispersants has been found that are based on polyurethanes which are derived from alkoxy aromatic diols. The ionic content in these dispersants can come from the isocyanate-reactive components that have ionic substitution.

In order for a dispersant to stably disperse a particle, the dispersion must be stable for at least a week when stored at room temperature. When the dispersion is observed after being stored after a week, a stable dispersion would still have less than 5% clear liquid on the top of the dispersion. If there is clear liquid, this indicates that the dispersion has become unstable and may be flocculating. For specific applications heating the dispersions for a set time can be done to determine relative stability among different dispersions. Another criteria for stability is to measure properties of the dispersion, such as viscosity, particle size, pH, conductivity and the like. Comparing particle size is a good way to determine dispersion stability. For the pigments used in inkjet inks the average particle size should be less than about 300 nm.

While not being bound by theory, it is speculated that the aromatic part of the first or second polyurethane dispersant is especially compatible with the chemical structures of pigments which often can have aromatic groups in their chemical structures. Carbon black is an example of aromatic containing pigment for this first or second polyurethane dispersant since the carbon black molecular structure is aromatic in nature. Quinacridones, phthalocyanines, and azobenzenes are also common examples of pigments with aromatic groups in their structure. In addition to the aromatic to aromatic potential interaction, the flexibility of the alkoxy substituents may lead to significant rotational freedom of the aromatic substructures in the alkoxy aromatic diol allowing for enhanced interaction with the pigment surfaces. In contrast, aromatic groups derived from the isocyanates used in the polyurethane synthesis will have some inherent rigidity as the aromatic group is adjacent to the urethane group.

As the ink is jetted onto the substrate, often the pigment will penetrate into the substrate as the vehicle absorbs and travels into substrate. As a result of enhanced pigment interactions, pigments with the polyurethane derived from alkoxy aromatic diols may be held more effectively on the substrate surface as the ink dries. This polyurethane/pigment compatibility may lead to a more homogeneous/uniform image on the substrate, thus resulting in less light scatter and good optical density.

### Colorants

The colorants in this invention are pigments. Other colorants may be used in combination with polyurethane ionic dispersed pigments.

Pigments suitable for use in the present invention are those generally well-known in the art for aqueous inkjet inks. Representative commercial dry pigments are listed in U.S. Pat. No. 5,085,698. Dispersed dyes are also considered pigments as they are insoluble in the aqueous inks used herein.

Pigments which have been stabilized by the first or second polyurethane dispersant may also have these dispersants crosslinked after the pigments are dispersed. An example of this crosslinking strategy is described in U.S. Pat. No. 6,262,152.

Polymerically dispersed pigments are prepared by mixing the polymeric dispersants and the pigments and subjecting the mixture to dispersing conditions. It is generally desirable to make the stabilized pigment in a concentrated form. The stabilized pigment is first prepared by premixing the selected pigment(s) and polyurethane ionic dispersant(s) in an aqueous carrier medium (such as water and, optionally, a water-miscible solvent), and then dispersing or deflocculating the pigment. The dispersing step may be accomplished in a 2-roll mill, media mill, a horizontal mini mill, a ball mill, an attritor, or by passing the mixture through a plurality of nozzles within a liquid jet interaction chamber at a liquid pressure of at least 5,000 psi to produce a uniform dispersion of the pigment particles in the aqueous carrier medium (microfluidizer). Alternatively, the concentrates may be prepared by dry milling the polymeric dispersant and the pigment under pressure. The media for the media mill is chosen from commonly available media, including zirconia, YTZ and nylon. Preferred are 2-roll mill, media mill, and by passing the mixture through a plurality of nozzles within a liquid jet interaction chamber at a liquid pressure of at least 5,000 psi.

After the milling process is complete the pigment concentrate may be “let down” into an aqueous system. “Let down” refers to the dilution of the concentrate with mixing or dispersing, the intensity of the mixing/dispersing normally being determined by trial and error using routine methodology, and often being dependent on the combination of the polymeric dispersant, solvent and pigment.

A wide variety of organic and inorganic pigments, alone or in combination, may be selected to make the ink. The term “pigment” as used herein means an insoluble colorant which includes disperse dyes as they are insoluble in the inkjet ink. The pigment particles are sufficiently small to permit free flow of the ink through the inkjet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from flocculation. It is also desirable to use small particles for maximum color strength and gloss. The range of useful particle size is typically about 0.005 micron to about 15 micron. Preferably, the pigment particle size should range from about 0.005 to about 5 micron and, most preferably, from about 0.005 to about 1 micron. The average particle size as measured by dynamic light scattering is preferably less than about 500 nm, more preferably less than about 300 nm.

The selected pigment(s) may be used in dry or wet form. For example, pigments are usually manufactured in aqueous media and the resulting pigment is obtained as water-wet presscake. In presscake form, the pigment is not agglomerated to the extent that it is in dry form. Thus, pigments in water-wet presscake form do not require as much deflocculation in the process of preparing the inks as pigments in dry form.

### First Polyurethane Dispersant

The first polyurethane dispersant is derived from alkoxy aryl diols, diols substituted with an ionic group, and isocyanates

where the alkoxy aryl diol is Z₁

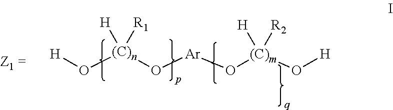

wherein Ar is an aromatic group,
n, m, p, and q are integers.
n, m are the same or different and are greater than or equal to 2 to 12,
p is greater than or equal to 1 to 15,
q is greater than or equal to 0 to 15,
R₁, R₂ are the same or different and each is independently selected from the group consisting of hydrogen, methyl, ethyl and higher alkyls of the formula of CₜH₂ₜ₊₁; where t is an integer and is greater than or equal to 3 to 36.
Z₂ is a diol substituted with an ionic group; and
at least one Z₁ and at least one Z₂ must be present in the polyurethane composition.

The first polyurethane dispersant derived from an alkoxy aromatic diol is either in the form of a water soluble polyurethane or an aqueous polyurethane dispersion. The term “polyurethane dispersion” refers to aqueous dispersions of polymers containing urethane groups and optionally urea groups, as that term is understood by those of ordinary skill in the art. These polyurethane polymers also incorporate hydrophilic functionality to the extent required to maintain a stable dispersion of the polymer in water and/or as a soluble polyurethane ionic dispersant, especially in the neutralized form. The Z₂ diol containing the ionic group provides the ionic stabilization for the polyurethane dispersion.

The preparation of a first polyurethane dispersant derived from alkoxy aromatic diols comprises the steps:

(a) providing reactants comprising (i) at least one alkoxy aromatic diol Z₁ component, (ii) at least one polyisocyanate component, and (iii) at least one hydrophilic reactant comprising at least one isocyanate reactive ingredient containing an ionic group, Z₂,

(b) reacting (i), (ii) and (iii) in the presence of a water-miscible organic solvent to form an isocyanate-functional polyurethane pre-polymer;

(c) adding water to form an aqueous dispersion; and

(d) prior to, concurrently with or subsequent to step (c), chain-terminating the isocyanate-functional prepolymer.

For step (a) the reactants may be added in any convenient order.

Z₂ contains ionizable groups and at the time of addition of water (step (c)), the ionizable groups may be ionized by adding acid or base (depending on the type of ionizable group) in an amount such that the polyurethane can be soluble or stably dispersed. This neutralization can occur at any convenient time during the preparation of the polyurethane.

At some point during the reaction (generally after addition of water and after chain termination), the organic solvent is substantially removed under vacuum to produce an essentially solvent-free dispersion. Alternatively, suitable, non-volatile solvents may be used and left in the polyurethane dispersion.

It should be understood that the process used to prepare the polyurethane generally results in a polyurethane polymer of the above structure being present in the final product. However, the final product will typically be a mixture of products, of which a portion is the above polyurethane polymer, the other portion being a normal distribution of other polymer products and may contain varying ratios of unreacted monomers. The heterogeneity of the resultant polymer will depend on the reactants selected as well as reactant conditions chosen.

### Alkoxy Aromatic Diol Component of the Polyurethane Ionic Dispersant

The alkoxy aromatic diol, Z₁, is based on aromatic compounds which have at least two oxygens substituted on the aromatic ring. When p and q are at least one each of the oxygens can be substituted with an alkyl or a substituted alkyl group including alkoxy and hydroxyl substituents. When p is at least one and q is 0, one of the oxygens is substituted with the alkyl group or a substituted group and one is bonded to a hydrogen atom. The oxygen substituents can be at any location on the aromatic ring. The aromatic group may have other alkyl substituents.

The aromatic group may be a single aromatic ring or multiple aromatic rings either single bonded such as biphenyl derivatives, or multiple bonded such as naphthalenic derivatives. The aromatic group may also have two aromatic groups which are not bonded together, but bonded through an alkyl group, or a heteroatom group. An example of an aromatic group with an alkyl group between two aromatic groups is bis-phenol compound where the alkyl group is a 2 propyl group. Examples of diols containing a hetero atom include diols derivative of benzophenone or 4,4′-sulfonyl diphenol.

Examples of an aromatic group with a single aromatic ring include hydroquinone derivatives; two aromatic rings include naphthalene derivatives where the two oxygens can be on the same or different aromatic ring of the naphthalene; and similarly substituted anthracene and higher arenes with two oxygen substituents. Examples of aromatic groups where the aromatic groups are single bonded to one another include biphenyl with two oxygen groups either on the same aromatic group or different aromatic groups. Examples of aromatic groups with at least two aromatic groups which are not bonded to each other but through alkyl or a heteroatom group include alkoxy substituted bis phenol A, alkoxy substituted 4,4′-sulfonyl diphenol, and benzophenone diol.

The alkyl group of the alkoxy group is a {CH(R₁)}ₜ where t is 2 to 12, which corresponds to the n and m in structure Z₁ and R₁ is hydrogen or alkyl. When t is 2 and R₁ is hydrogen the alkoxy group corresponds to an ethylene oxide derivative. When t is 2 and one of the {CH(R₁)} groups has the R₁ equal to methyl, the alkoxy group is derived from a 1,2 propylene oxide. When t is greater than 3 the alkoxy group may be obtained from ring opening of the corresponding oxetane or other common synthetic pathways to alpha, omega diols. R₁ can be an alkyl group up to 22 carbons and can be branched and cyclic.

While these alkoxy aromatic diols may be somewhat colored, usually they are only a slight yellow color when they are dissolved in a compatible solvent. The alkoxy aromatic diols of the invention are not pigments or dyes.

For instance, POLY-G® HQEE commercially available from Arch Chemicals, Brandenburg, Ky., U.S.A., the yellowness index measured in a THF solution is limited to 50 units as calculated by the ASTM D 1925 formula using CIE Illuminant C and the CIE 1931 Standard Observer. HQEE is a hydroquinone derivative reacted with approximately 2 equivalents of ethylene oxide. Likewise, ethoxylated bisphenol A (Macol 202 and 209 from BASF) has a maximum color of 2 on the Gardner scale.

Diol Substituted with an Ionic Group

The diol substituted with an ionic group contains ionic and/or ionizable groups. Preferably, these reactants will contain one or two, more preferably two, isocyanate reactive groups, as well as at least one ionic or ionizable group. In the structural description of the polyurethanes with alkoxy aromatic diols described herein the reactant containing the ionic group is designated as Z₂.

Examples of ionic dispersing groups include carboxylate groups (—COOM), phosphate groups (—OPO₃ M₂), phosphonate groups (—PO₃ M₂), sulfonate groups (—SO₃ M), quaternary ammonium groups (—NR₃Y, wherein Y is a monovalent anion such as chlorine or hydroxyl), or any other effective ionic group. M is a cation such as a monovalent metal ion (e.g., Na⁺, K⁺, Li⁺, etc.), H⁺, NR₄⁺, and each R is independently an alkyl, aralkyl, aryl, or hydrogen. These ionic dispersing groups are typically located pendant from the polyurethane backbone.

The ionizable groups in general correspond to the ionic groups, except they are in the acid (such as carboxyl —COOH) or base (such as primary, secondary or tertiary amine —NH₂, —NRH, or —NR₂) form. The ionizable groups are such that they are readily converted to their ionic form during the dispersion/polymer preparation process as discussed below.

The ionic or potentially ionic groups are chemically incorporated into the polyurethanes derived from alkoxy aromatic diols in an amount to provide an ionic group content (with neutralization as needed) sufficient to render the polyurethane dispersible in the aqueous medium of the dispersion. Typical ionic group content will range from about 0.15 up to about 1.8 milliequivalents (meq), optionally, from about 0.36 to about 1.07 meq. per 1 g of polyurethane solids.

With respect to compounds which contain isocyanate reactive groups and ionic or potentially ionic groups, the isocyanate reactive groups are typically amino and hydroxyl groups. The potentially ionic groups or their corresponding ionic groups may be cationic or anionic, although the anionic groups are most often used. Examples of anionic groups include carboxylate and sulfonate groups. Examples of cationic groups include quaternary ammonium groups and sulfonium groups.

In the case of anionic group substitution, the groups can be carboxylic acid groups, carboxylate groups, sulphonic acid groups, sulphonate groups, phosphoric acid groups and phosphonate groups. The acid salts are formed by neutralizing the corresponding acid groups either prior to, during or after formation of the NCO pre-polymer preferably after formation of the NCO pre-polymer.

Preferred carboxylic group-containing compounds are the hydroxy-carboxylic acids corresponding to the structure (HO)ⱼQ(COOH)ₖ wherein Q represents a straight or branched, hydrocarbon radical containing 1 to 12 carbon atoms, j is 1 or 2, preferably 2 and k is 1 to 3, preferably 1 or 2 and more preferably 1.

Examples of these hydroxy-carboxylic acids include citric acid, tartaric acid and hydroxypivalic acid. Especially preferred acids are those of the above-mentioned structure wherein j=2 and k=1. These dihydroxy alkanoic acids are described in U.S. Pat. No. 3,412,054, Especially preferred dihydroxy alkanoic acids are the alpha, alpha-dimethylol alkanoic acids represented by the structural formula:

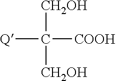

wherein Q′ is hydrogen or an alkyl group containing 1 to 8 carbon atoms. The most commonly used diol compound is alpha, alpha-dimethylol propionic acid, i.e., wherein Q′ is methyl in the above formula.

In order to have a stable dispersion of the polyurethane derived from alkoxy aromatic diols ink additive, a sufficient amount of the ionic groups must be neutralized so that, the resulting polyurethane will remain stably dispersed in the aqueous medium. Generally, at least about 75%, optionally at least about 90%, of the ionic groups are neutralized to the corresponding salt groups.

Suitable neutralizing agents for converting the acid groups to salt groups before, during, or after their incorporation into the NCO pre-polymers, include tertiary amines, alkali metal cations and ammonia. Preferred trialkyl substituted tertiary amines, such as triethyl amine, tripropyl amine, dimethylcyclohexyl amine, and dimethylethyl amine.

Neutralization may take place at any point in the polyurethane synthesis. A typical procedure includes at least some neutralization of the pre-polymer.

When the ionic stabilizing groups are acids, the acid groups are incorporated in an amount sufficient to provide an acid group content for the urea-terminated polyurethane, known by those skilled in the art as acid number (mg KOH per gram solid polymer), at least about 8 milligrams KOH per 1.0 gram of polyurethane and optionally 20 milligrams KOH per 1.0 gram of polyurethane. The upper limit for the acid number is about 100 and optionally about 60.

The first or second polyurethane dispersant derived from alkoxy aromatic diols has a number average molecular weight of about 2000 to about 30,000. Optionally, the molecular weight is about 3000 to 20000.

The first or second polyurethane dispersant is a generally stable aqueous dispersion of polyurethane particles having a solids content of up to about 60% by weight, specifically, about 15 to about 60% by weight and most specifically, about 20 to about 45% by weight. However, it is always possible to dilute the dispersions to any minimum solids content desired.

### Other Isocyanate-Reactive Components

The first or or second polyurethane dispersant derived from alkoxy aromatic diols above may be blended with other polyfunctional isocyanate-reactive components, most notably oligomeric and/or polymeric polyols. These other polyfunctional isocyanate-reactive components are limited to no more than 50 mole percent based on all of the isocyanate-reactive components. These other isocyanate reactive components are chosen for their stability to hydrolysis

Suitable other diols contain at least two hydroxyl groups, and have a molecular weight of from about 60 to about 6000. Of these, the polymeric diols are best defined by the number average molecular weight, and can range from about 200 to about 6000, specifically, from about 400 to about 3000, and more specifically from about 600 to about 2500. The molecular weights can be determined by hydroxyl group analysis (OH number).

Examples of polymeric polyols include polyesters, polyethers, polycarbonates, polyacetals, poly(meth)acrylates, polyester amides, and polythioethers. A combination of these polymers can also be used. For examples, a polyether polyol and a poly (meth)acrylate polyol may be used in the same polyurethane synthesis. In the case of using a polyether polyol, both ionic (from Z₂) and nonionic stabilization (from the polyether polyol) can contribute to the stabilization of the polyurethane ionic dispersant. The polyether polyol can be a diol derived from ethylene oxide, propylene oxide and similar oxetanes and as such contribute nonionic stabilization to the polyurethane ionic dispersant.

The polycarboxylic acids may be aliphatic, cycloaliphatic, aromatic and/or heterocyclic or mixtures thereof and they may be substituted, for example, by halogen atoms, and/or unsaturated.

In addition to the above-mentioned components, which are difunctional in the isocyanate polyaddition reaction, mono-functional and even small portions of trifunctional and higher functional components generally known in polyurethane chemistry, such as trimethylolpropane or 4-isocyanantomethyl-1,8-octamethylene diisocyanate, may be used in cases in which branching of the NCO pre-polymer or polyurethane is desired.

It is, however, preferred that the NCO-functional pre-polymers should be substantially linear, and this may be achieved by maintaining the average functionality of the pre-polymer starting components at or below 2:1.

### Isocyanate Component

Suitable polyisocyanates are those that contain either aromatic, cycloaliphatic or aliphatic groups bound to the isocyanate groups. Mixtures of these compounds may also be used. Preferred are compounds with isocyanates bound to a cycloaliphatic or aliphatic moieties. If aromatic isocyanates are used, cycloaliphatic or aliphatic isocyanates are preferably present as well.

Diisocyanates are preferred, and any diisocyanate useful in preparing polyurethanes and/or polyurethane-ureas from polyether glycols, diisocyanates and diols or amine can be used in this invention.

Examples of suitable diisocyanates include, but are not limited to, 2,4-toluene diisocyanate (TDI); 2,6-toluene diisocyanate; trimethyl hexamethylene diisocyanate (TMDI); 4,4′-diphenylmethane diisocyanate (MDI); 4,4′-dicyclohexylmethane diisocyanate (H₁₂MDI); 3,3′-dimethyl-4,4′-biphenyl diisocyanate (TODD; Dodecane diisocyanate (C₁₂DI); m-tetramethylene xylylene diisocyanate (TMXDI); 1,4-benzene diisocyanate; trans-cyclohexane-1,4-diisocyanate; 1,5-naphthalene diisocyanate (NDI); 1,6-hexamethylene diisocyanate (HDI); 4,6-xylyene diisocyanate; isophorone diisocyanate (IPDI); and combinations thereof. IPDI and TMXDI are most suitable.

Small amounts, less than about 3 wt % based on the weight of the diisocyanate, of monoisocyanates or polyisocyanates can be used in mixture with the diisocyanate. Examples of useful monoisocyanates include alkyl isocyanates such as octadecyl isocyanate and aryl isocyanates such as phenyl isocyanate. Example of a polyisocyanate are triisocyanatotoluene, HDI trimer (Desmodur 3300), and polymeric MDI (Mondur MR and MRS).

### Ratios of Polyurethane Components

For both the first and second polyurethane described above the ratio of isocyanate to isocyanate reactive groups is from about 1.3:1 to about 1.0:1, and suitably from about 1.25:1 to about 1.05:1. In the case where the isocyanate groups are more than the isocyanate reactive groups, often a chain termination group is used. This chain termination groups can include alcohols and amines.

The amount of chain terminator employed should be approximately equivalent to the unreacted isocyanate groups in the prepolymer. The ratio of active hydrogens from amine groups in the chain terminator to isocyanate groups in the prepolymer are in the range from about 1.0:1 to about 1.2:1, suitably from about 1.0:1.1 to about 1.1:1, and suitably from about 1.0:1.05 to about 1.1:1, on an equivalent basis.

In addition to alcohols, aliphatic primary or secondary monoamines are commonly used as the chain termination agents. Example of monoamines useful as chain terminators include but are not restricted to butylamine, hexylamine, 2-ethylhexyl amine, dodecyl amine, diisopropanol amine, stearyl amine, dibutyl amine, dinonyl amine, bis(2-ethylhexyl)amine, diethylamine, bis(methoxyethyl)amine, N-methylstearyl amine, diethanolamine and N-methyl aniline.

When the chain termination agent is an amine, the second polyurethane dispersant has the structure (II)

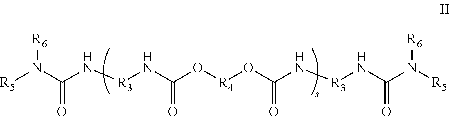

R₃ is alkyl, substituted alkyl, substituted alkyl/aryl from diisocyanate,

R₄ is Z₁ or Z₂,

R₅ is hydrogen; alkyl; branched alkyl or substituted alkyl from the amine terminating group,

R₆ is alkyl, branched alkyl or substituted alkyl from the amine terminating group,

s is an integer greater than or equal to 2 to 30;
Z₁ or Z₂ are defined above as the alkoxy aromatic diol and Z₂ as the diol substituted with an ionic group.

Thus, structure (II) is a polyurethane as described above as the second polyurethane, but the end groups are limited to amine termination of the polyurethane prepolymer. The second polyurethane is a subset of the first polyurethane in that the first polyurethane can have different terminal groups.

Any primary or secondary monoamines reactive with isocyanates may be used as chain terminators. Aliphatic primary or secondary monoamines are preferred. Example of monoamines useful as chain terminators include but are not restricted to butylamine, hexylamine, 2-ethylhexyl amine, dodecyl amine, diisopropanol amine, stearyl amine, dibutyl amine, dinonyl amine, bis(2-ethylhexyl)amine, diethylamine, bis(methoxyethyl)amine, N-methylstearyl amine and N-methyl aniline. An optional isocyanate reactive chain terminator is bis(methoxyethyl)amine. The bis(methoxyethyl)amine is part of a class of urea terminating reactant where the substituents are non reactive in the isocyanate chemistry, but have nonionic hydrophillic groups. This nonionic hydrophilic group provides the urea terminated polyether diol polyurethane with more water compatible.

The urea content in percent of the second polyurethane dispersant is determined by dividing the mass of chain terminator by the sum of the other polyurethane components including the chain terminating agent. The urea content will be from about 2 wt % to about 14.5 wt %. The urea content will be preferably from about 2.5 wt % to about 10.5 wt %.

It is important that this urea group be the terminating group and there are no substituents in the chain terminating group that can lead to crosslinking or bridging to another polyurethane. Thus, R₅ and R₆ are each described as not having any isocyanate reactive groups. R₅ may be hydrogen.

The second polyurethane dispersant is prepared in a manner similar to what is described for the first polyurethane dispersant.

### Aqueous Vehicle

Selection of a suitable aqueous vehicle mixture depends on requirements of the specific application, such as desired surface tension and viscosity, the selected colorant, drying time of the ink, and the type of substrate onto which the ink will be printed. Representative examples of water-soluble organic solvents which may be utilized in the present invention are those that are disclosed in U.S. Pat. No. 5,085,698.

If a mixture of water and at least one water-miscible solvent is used, the aqueous vehicle typically will contain about 30% to about 95% water with the balance (i.e., about 70% to about 5%) being the water-soluble solvent. Compositions of the present invention may contain about 60% to about 95% water, based on the total weight of the aqueous vehicle.

The amount of aqueous vehicle in the ink is typically in the range of about 70% to about 99.8%, suitably about 80% to about 99.8%, based on total weight of the ink.

The aqueous vehicle can be made to be fast penetrating (rapid drying) by including surfactants or penetrating agents such as glycol ethers and 1,2-alkanediols. Suitable surfactants include ethoxylated acetylene diols (e.g. Surfynols® series commercially available from Air Products), ethoxylated primary (e.g. Neodol® series commercially available from Shell) and secondary (e.g. Tergitol® series commercially available from Union Carbide) alcohols, sulfosuccinates (e.g. Aerosol® series commercially available from Cytec), organosilicones (e.g. Silwet® series commercially available from Witco) and fluoro surfactants (e.g. Zonyl® series commercially available from DuPont).

The amount of glycol ether(s) and 1,2-alkanediol(s) added must be properly determined, but is typically in the range of from about 1 to about 15% by weight and more typically about 2 to about 10% by weight, based on the total weight of the ink. Surfactants may be used, typically in the amount of about 0.01 to about 5% and preferably about 0.2 to about 2%, based on the total weight of the ink.

### Proportion of Main Ingredients

The pigment levels employed in the instant inks are those levels which are typically needed to impart the desired color density to the printed image. Typically, pigment levels are in the range of about 0.05 to about 10% by weight of the ink. The amount of first or second polyurethane dispersants required to stabilize the pigment is dependent upon the specific polyurethane ionic dispersants, the pigment and vehicle interaction. The weight ratio of pigment to first or second polyurethane dispersant will typically range from about 0.5 to about 6.

Preparation of the Pigment Dispersion

The polyurethane dispersants are dispersants for pigments. In this case, the polyurethane is either 1) utilized as a dissolved polyurethane in a compatible solvent where the initial polyurethane/particle mixture is prepared and then processed using dispersion equipment to produce the aqueous polyurethane dispersed pigment; or 2) the polyurethane dispersion and the pigment dispersed are mixed in a water miscible solvent system which, in turn is processed using dispersion equipment to produce the aqueous polyurethane dispersed pigment where the polyurethane is the dispersant. While not being bound by theory, it is assumed that the pigment and the polyurethane have the appropriate physical/chemical interactions that are required to prepare a stable dispersion of particles especially pigments. Furthermore, it is possible that some of the polyurethane is not bound to the pigment and exists either as a dispersion of the polyurethane or polyurethane dissolved in the liquid phase of the dispersion.

The water miscible solvent is chosen to assure that during the particle dispersion process the polyurethane can function as a dispersant, that is, the polyurethane becomes the dispersant for the pigment. Candidate water miscible solvents include dipropylene glycol methyl ether, propylene glycol normal propyl ether, ethylene glycol monobutyl ether, diethylene glycol monobutyl ether, isopropyl alcohol, 2-pyrrolidone, triethylene glycol monobutyl ether, tetraglyme, sulfolane, n-methylpyrrolidone, propylene carbonate, methyl ethyl ketone, methyl isobutyl ketone, butyrolactone.

After the polyurethane dispersant dispersion preparation, the amount of water-miscible solvent may be more than some ink jet applications will tolerate. For some of the urea terminated polyurethane dispersions, it thus may be necessary to ultrafilter the final dispersion to reduce the amount of water-miscible solvent. To improve stability and reduce the viscosity of the pigment dispersion, it may be heat treated by heating from about 30° C. to about 100° C., with the preferred temperature being about 70° C. for about 10 to about 24 hours. Longer heating does not affect the performance of the dispersion.

While not being bound by theory, it is believed that the polyurethane ionic dispersions provide improved ink properties by the following means. Stable aqueous dispersions are critical for inkjet inks to assure long-lived ink cartridges having few problems with failed nozzles, etc. It is, however, desirable for the ink to become unstable as it is jetted onto the media so that the pigment in the ink “crashes out” onto the surface of the media (as opposed to being absorbed into the media). With the pigment on the surface of the media, beneficial properties of the ink can be obtained.

The polyurethane dispersants provide novel dispersants that sufficiently stabilize the ink prior to jetting (such as in the cartridge) but, as the ink is jetted onto the paper, the pigment system is destabilized and the pigment remains on the surface of the media. This leads to improved ink properties.

### Other Ink Ingredients

Other ingredients may be formulated into the inkjet ink, to the extent that such other ingredients do not interfere with the stability and jetability of the ink, which may be readily determined by routine experimentation. Such other ingredients are in a general sense well known in the art.

Biocides may be used to inhibit growth of microorganisms.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), diethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

### Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, i.e., driving frequency of the piezo element, or ejection conditions for a thermal head, for either a drop-on-demand device or a continuous device, and the shape and size of the nozzle. The inks should have excellent storage stability for long periods so as not to clog to a significant extent in an ink jet apparatus. Further, the ink should not corrode parts of the ink jet printing device it comes in contact with, and it should be essentially odorless and non-toxic.

Although not restricted to any particular viscosity range or printhead, the inventive ink set is particularly suited to lower viscosity applications such as those required by thermal printheads. Thus, the viscosity (at 25° C.) of the inventive inks can be less than about 7 cP, is preferably less than about 5 cP, and most advantageously is less than about 3.5 cP. Thermal inkjet actuators rely on instantaneous heating/bubble formation to eject ink drops and this mechanism of drop formation generally requires inks of lower viscosity.

### Substrate

The instant invention is particularly advantageous for printing on plain paper, such as common electrophotographic copier paper and photo paper, glossy paper and similar papers used in inkjet printers. Textiles can also be used as a substrate.

### EXAMPLES

### Extent of Polyurethane Reaction

The extent of polyurethane reaction was determined by detecting NCO % by dibutylamine titration, a common method in urethane chemistry. In this method, a sample of the NCO containing pre-polymer is reacted with a known amount of dibutylamine solution and the residual amine is back titrated with HCl.

### Particle Size Measurements

The particle size for the polyurethane dispersions, pigments and the inks were determined by dynamic light scattering using a MICROTRAC UPA 150 analyzer from Honeywell/Microtrac (Montgomeryville Pa.).

This technique is based on the relationship between the velocity distribution of the particles and the particle size. Laser generated light is scattered from each particle and is Doppler shifted by the particle Brownian motion. The frequency difference between the shifted light and the unshifted light is amplified, digitalized and analyzed to recover the particle size distribution.

### Solid Content Measurement

Solid content for the solvent free polyurethane dispersions was measured with a moisture analyzer, model MA50 commercially available from Sartorius. For polyurethane dispersions containing high boiling solvent, such as NMP, tetraethylene glycol dimethyl ether, the solid content was then determined by the weight differences before and after baking in 150° C. oven for 180 minutes. Other solvents used were Proglyde DMM commercially available from Dow Chemical (dipropylene glycol dimethyl ether) and sulfolane.

### Molecular Weight Characterization of the Polyurethane Additive

All molecular weights were determined by GPC using poly (methyl methacrylate) standards with tetrahydrofuran as the eluent. Using statics derived by Flory, the molecular weight of the polyurethane may be calculated or predicted based on the NCO/OH ratio and the molecular weight of the monomers. Molecular weight is also a characteristic of the polyurethane that can be used to define the polyurethane. The molecular weight is routinely reported as number average molecular weight, Mn. For the polyurethane dispersant which is derived from alkoxy aromatic diol the molecular weight range is 2000 to 30000, or optionally 3000 to 20000 daltons. The polyurethane dispersant are not limited to Gaussian distribution of molecular weight, but may have other distributions such as bimodal distributions. All polyurethane dispersant examples are examples of the second polyurethane dispersant, except example 3.

### Polyurethane Dispersant Example 1

### TMXDI/HQEE BMEA 40 AN

A 2 L reactor was loaded with 69.4 g Poly-G HQEE (OH #555, Arch Chemical), 99.7 g tetraethylene glycol dimethyl ether, and 24.2 g dimethylol propionic acid. The reaction was heated to 77° C., and then, 0.47 g dibutyl tin dilaurate was added. Over 60 the course of minutes 147.67 g m-tetramethylene xylylene diisocyanate was added to the reactor followed by 12.16 g tetraethylene glycol dimethyl ether. Then, 20.21 g bis(2-methoxy ethyl)amine was added over the course of 30 minutes. The reaction was held at 80° C. until the NCO was less than 0.1%. The polyurethane solution was inverted under high speed mixing by adding a mixture of 45% KOH (20.2 g) and 282.6 g water followed by an additional 324.2 g water. The polyurethane dispersion had a viscosity of 21.3 cPs, 27.45% solids, pH 8.2, and particle size of d50=10.3 nm and d95=17.7 nm.

### Polyurethane Dispersant Example 2

### TMXDI/HQEE BMEA 60 AN

A 2 L reactor was loaded reactor with 52.34 g Poly-G HQEE (OH #555, Arch Chemical), 94.32 g tetraethylene glycol dimethyl ether, and 35.92 g dimethylol propionic acid. The reaction was heated to 77° C., and then, 0.59 g dibutyl tin dilaurate was added. Over the course of 60 minutes 148.4 g m-tetramethylene xylylene diisocyanate was added to the reactor followed by 12.25 g tetraethylene glycol dimethyl ether. Then, 20.21 g bis(2-methoxy ethyl)amine was added over the course of 30 minutes. The reaction was held at 80° C. for 26 hrs until the NCO was less than 0.2%. The polyurethane solution was inverted under high speed mixing by adding a mixture of 45% KOH (30.1 g) and 421.2 g water followed by an additional 185.9 g water. The polyurethane dispersion had a viscosity of 28.6 cPs, 28.46% solids, pH 7.9, and particle size of d50=6.7 nm and d95=8.9 nm.

### Polyurethane Dispersant Example 3

### TMXDI/HQEE EtOH 40AN

A 2 L reactor was loaded reactor with 69.32 g Poly-G HQEE (OH #555, Arch Chemical), 100.1 g tetraethylene glycol dimethyl ether, and 24.65 g dimethylol propionic acid. The reaction was heated to 77° C., and then, 0.56 g dibutyl tin dilaurate was added. Over the course of 60 minutes 147.8 g m-tetramethylene xylylene diisocyanate was added to the reactor followed by 12.2 g tetraethylene glycol dimethyl ether. Then, 6.98 g ethanol (200 proof) was added over the course of 30 minutes. The reaction was held at 80° C. for 21 hrs until the NCO was less than 0.1%. The polyurethane solution was inverted under high speed mixing by adding a mixture of 45% KOH (20.2 g) and 282.7 g water followed by an additional 387.4 g water. The polyurethane dispersion had a viscosity of 13.1 cPs, 26.49% solids, pH 7.95, and particle size of d50=14.3 nm and d95=22.4 nm. This polyurethane corresponds to the first, more general polyurethane structure.

### Polyurethane Dispersant Example 4

### IPDI/HQEE BMEA 60 AN

A 2 L reactor was loaded reactor with 66.8 g Poly-G HQEE (OH #555, Arch Chemical), 157.3 g sulfolane, and 39.5 g dimethylol propionic acid. The reaction was heated to 69° C. Over the course of 60 minutes 153.85 g isophorone diisocyanate was added to the reactor followed by 13.4 g sulfolane while the reaction temperature held at 80° C. reaching a maximum of 83.9° C. After 2.5 hr, the % NCO was below 1.6%, 16.8 g bis(2-methoxy ethyl)amine was added over the course of 10 minutes. The reaction was held at 80° C. for 1 hr. The polyurethane solution was inverted under high speed mixing by adding a mixture of 45% KOH (33.1 g) and 467.5 g water followed by an additional 159.4 g water. The polyurethane dispersion had a 27.56% solids, pH 7.53, and molecular weight by GPC of Mn 6655 with a polydispersity of 1.96. This polyurethane had a calculated 6.08% urea content.

### Polyurethane Dispersant Example 5

### TMXDI/15HQEE/BMEA 41 AN

A 2 L reactor was loaded reactor with 73.02 g Poly-G HQEE (OH #555, Arch Chemical), 104.08 g tetraethylene glycol dimethyl ether, and 24.37 g dimethylol propionic acid. The mixture was heated to 80° C. with N₂ purge, then, and 0.43 g dibutyl tin dilaurate was added. Over the course of 60 minutes 143.44 g m-tetramethylene xylylene diisocyanate was added to the reactor followed by 11.79 g tetraethylene glycol dimethyl ether. The reaction was held at 80° C. for 4.5 hrs until the NCO was less than 0.1%. Then, 9.82 g bis(2-methoxy ethyl)amine was added over the course of 10 minutes and continued heating for 1.5 hrs. The polyurethane solution was inverted under high speed mixing by adding a mixture of 45% KOH (20.39 g) and 285.39 g water followed by an additional 327.3 g water. The polyurethane dispersion had a viscosity of 10.4 cPs, 29.17% solids, pH 7.64, and particle size of d50=16.7 nm and d95=29.5 nm and molecular weight by GPC of Mn 4210 and PD 2.11.

### Polyurethane Dispersant Example 6

### TMXDI/HQEE BMEA 42 AN

A 2 L reactor was loaded reactor with 73.41 g Poly-G HQEE (OH #555, Arch Chemical), 105.22 g tetraethylene glycol dimethyl ether, and 25.05 g dimethylol propionic acid. The mixture was heated to 77° C. with N₂ purge, then, and 0.41 g dibutyl tin dilaurate was added. Over the course of 60 minutes 142.11 g m-tetramethylene xylylene diisocyanate was added to the reactor followed by 11.68 g tetraethylene glycol dimethyl ether. Then, 6.48 g bis(2-methoxy ethyl)amine was added over the course of 10 minutes and continued heating for 45 hr at which time the % NCO was 0.15%. The polyurethane solution was inverted under high speed mixing by adding a mixture of 45% KOH (20.96 g) and 293.4 g water followed by an additional 321.2 g water. The polyurethane dispersion had a viscosity of 29.9 cPs, 25.92% solids, pH 7.85, and particle size of d50=10.7 nm and d95=17.7 nm and molecular weight by GPC of Mn 6630 and PD 2.16.

### Polyurethane Dispersant Example 7

### TMXDI/HQEE BMEA 62 AN

A 2 L reactor was loaded reactor with 56.01 g Poly-G HQEE (OH #555, Arch Chemical), 99.61 g tetraethylene glycol dimethyl ether, and 37.16 g dimethylol propionic acid. The mixture was heated to 77° C. with N₂ purge, then, and 0.41 g dibutyl tin dilaurate was added. Over the course of 60 minutes 142.79 g m-tetramethylene xylylene diisocyanate was added to the reactor followed by 11.74 g tetraethylene glycol dimethyl ether. Then, 6.51 g bis(2-methoxy ethyl)amine was added over the course of 10 minutes and continued heating for 25 hr at which time the % NCO was 0.0%. The polyurethane solution was inverted under high speed mixing by adding a mixture of 45% KOH (31.12 g) and 435.64 g water followed by an additional 179 g water. The polyurethane dispersion had a viscosity of 42.5 cPs, 26.30% solids, pH 7.37, and particle size of d50=11.7 nm and d95=17.0 nm and molecular weight by GPC of Mn 5754 and PD 2.39.

### Polyurethane Dispersant Example 8

### TMXDI/HQEE BMEA 42AN

A 2 L reactor was loaded reactor with 67.6 g Poly-G HQEE (OH #555, Arch Chemical), 152.5 g tetraethylene glycol dimethyl ether, and 25.2 g dimethylol propionic acid. The reaction was heated to 110° C. for 1 hr then cooled to 60° C. and added 0.19 g dibutyl tin dilaurate. Over the course of 60 minutes 147.7 g m-tetramethylene xylylene diisocyanate was added to the reactor followed by 12.15 g tetraethylene glycol dimethyl ether. After 9 hr, the % NCO was 2.0%. Then, 20.2 g bis(2-methoxy ethyl)amine was added over the course of 5 minutes and continued heating for 30 min. The polyurethane solution was inverted under high speed mixing by adding a mixture of 45% KOH (21.1 g) and 295.1 g water followed by 258 g water. The polyurethane dispersion had a viscosity of 74.0 cPs, 27.25% solids, pH 8.05, and particle size of d50=23.5 nm and d95=29.0 nm and molecular weight by GPC of Mn 2000 and PD 1.94.

### Polyurethane Dispersant Example 9

### Macol (bisphenol A ethoxylate) IPDI/BisA9EO BMEA 53AN

A 2 L reactor was loaded reactor with 178.5 g Macol RD 209 E (619 MW Bisphenol A ethoxylate from BASF), 182.2 g sulfolane, and 40.3 g dimethylol propionic acid. The reaction was heated to 115° C. for 1 hr then cooled to 71° C. and added 0.23 g dibutyl tin dilaurate. Over the course of 60 minutes 141.0 g isophorone diisocyanate was added to the reactor followed by 28.2 g sulfolane while the reaction temperature held at 81° C. After 4 hr, the % NCO was less than 1%, and then, 12.1 g bis(2-methoxy ethyl)amine was added over the course of 10 minutes. The reaction was held at 80° C. for 1 hr. The polyurethane solution was inverted under high speed mixing by adding a mixture of 45% KOH (33.7 g) and 472.3 g water followed by an additional 413.2 g water and 1 g Proxel GXL. The polyurethane dispersion had a pH 7.86, 24.5% solids, and molecular weight by GPC of 7403 with a polydispersity of 2.5, and a surface tension of 46.62 dynes/cm.

### Polyurethane Dispersant Example 10

### with Bis[4-(2-hydroxyethoxy)phenyl]Sulfone BMEA

A 2 L reactor was loaded reactor with 134.9 g Bis[4-(2-hydroxyethoxy)phenyl]sulfone (338 MW Bisphenol S bis(2-hydroxyethyl)ether from Aldrich), 202.5 g sulfolane, and 44.7 g dimethylol propionic acid. The reaction was heated to 115° C. for 1 hr then cooled to 71° C. and added 0.32 g dibutyl tin dilaurate. Over the course of 60 minutes 178.8 g isophorone diisocyanate was added to the reactor followed by 34 g sulfolane while the reaction temperature held at 80° C. reaching a maximum of 92° C. Sulfolane (101 g) was added to the reaction to reduce viscosity. After 3.5 hr, the % NCO was 1.23%, and then, 19.5 g bis(2-methoxy ethyl)amine was added over the course of 10 minutes. The reaction was held at 80° C. for 1 hr. The polyurethane solution was inverted under high speed mixing by adding a mixture of 45% KOH (37.4 g) and 522.6 g water followed by an additional 327.1 g water and 3 g Proxel GXL. The polyurethane dispersion had a viscosity of 130 cPs, 27.6% solids, pH 7.54, and molecular weight by GPC of Mn 5312 with a polydispersity of 1.71, and a surface tension of 45.82 dynes/cm.

### Polyurethane Dispersant Example 11

### IPDI/HQEE Tego, BMEA

A 2 L reactor was loaded reactor with 23.3 g Poly-G HQEE (OH #555, Arch Chemical), 86.3 g sulfolane, 140.9 g Tegomer D 3403, and 14.9 g dimethylol propionic acid. The reaction was heated to 115° C. for 1 hr then cooled to 79° C. and added 0.15 g dibutyl tin dilaurate. Over the course of 60 minutes 82.7 g isophorone diisocyanate was added to the reactor followed by 20.5 g sulfolane while the reaction temperature held at 85° C. reaching a maximum of 87.3° C. After 2 hr, the % NCO was below 1.0%, 32.0 g Jeffamine M600 was added over the course of 14 minutes. The reaction was held at 85° C. for 1 hr. The polyurethane solution was inverted under high speed mixing by adding a mixture of 45% KOH (32.0 g) and 467.5 g water followed by an additional 159.4 g water. The polyurethane dispersion had a 23.5% solids, pH 4.9, and viscosity of 23.4 cPs, molecular weight by GPC of Mn 6285 with a polydispersity of 1.64.

### Comparison Polyurethane Dispersant Example 1

### T250 Acid Number 40

A 2 L reactor was loaded reactor with 114.5 g Terathane 250 (250 MW poly(tetrahydrofuran from Invista), 123.9 g tetraglyme, and 36.3 g dimethylol propionic acid. The reaction was heated to 50° C. and added 0.23 g dibutyl tin dilaurate. Over the course of 60 minutes 183.2 g isophorone diisocyanate was added to the reactor followed by 30.1 g tetraglyme while the reaction temperature exothermed to 63° C. The reaction temperature was raised to 80° C., and over 400 min, the % NCO decreased to 1.2%. The reaction was cooled to 45° C. Then, 91.5 g bis(2-methoxy ethyl)amine was added over the course of 1 minute. After 0.5 hr, the polyurethane solution was inverted under high speed mixing by adding a mixture of 45% KOH (30.3 g) and 424.8 g water followed by additional 465.3 g water. The polyurethane dispersion had a pH 9.26, 23.97% solids, number average molecular weight (Mn) by GPC of 3767 with a polydispersity of 2.02, and a viscosity of 37.8.

### Comparison Polyurethane Dispersant Example 2

### t250 Acid Number 60

A 2 L reactor was loaded reactor with 85.3 g Terathane 250 (250 MW poly(tetrahydrofuran from Invista), 114.4 g tetraglyme, and 53.9 g dimethylol propionic acid. The reaction was heated to 50° C. and added 0.23 g dibutyl tin dilaurate. Over the course of 60 minutes 187.4 g isophorone diisocyanate was added to the reactor followed by 30.8 g tetraglyme. The reaction temperature was raised to 75° C., and over 5 hr, the % NCO decreased to 1.9%. The reaction was cooled to 45° C. Then, 93.6 g bis(2-methoxy ethyl)amine was added over the course of 1 minute. After 0.5 hr, the polyurethane solution was inverted under high speed mixing by adding a mixture of 45% KOH (45.1 g) and 631.7.8 g water followed by additional 657.5 g water. The polyurethane dispersion had a pH 8.77, 23.31% solids, and a viscosity of 42.5.

### Polyurethane Ink Additive

699.2 g Desmophene C 200, 280.0 g acetone and 0.06 g DBTL was added to a dry, alkali- and acid-free flask, equipped with an addition funnel, a condenser, stirrer and a nitrogen gas line. The contents were heated to 40° C. and mixed well. 189.14 g IPDI was then added to the reactor via the addition funnel at 40° C. over the course of 60 min, with any residual IPDI being rinsed from the addition funnel into the flask with 15.5 g acetone.

The flask temperature was raised to 50° C., then held for 30 minutes. 44.57 g DMPA followed by 25.2 g TEA was added to the flask via the addition funnel, which was then rinsed with 15.5 g acetone. The flask temperature was then raised again to 50° C. and held at 50° C. until NCO % was less than 1.23%.

With the temperature at 50° C., 1498.0 g deionized (DI) water was added over the course of 10 minutes, followed by mixture of 24.4 g EDA (as a 6.25% solution in water) and 118.7 g TETA (as a 6.25% solution in water) over 5 minutes, via the addition funnel, which was then rinsed with 80.0 g water. The mixture was held at 50° C. for 1 hr, then cooled to room temperature.

Acetone (−310.0 g) was removed under vacuum, leaving a final dispersion of polyurethane with about 35.0% solids by weight.

### Preparation of Polyurethane Stabilized Pigmented Dispersions

The pigment dispersions were prepared using an Eiger Minimill, media milling process. A two-step process involved a first Premix step followed by a second grinding or milling step. The first step comprised mixing the dispersion ingredients that is, pigment, dispersants, liquid carriers, and pH adjuster to provide a blended “premix”. Typically all liquid ingredients were added first, followed by the dispersants and lastly the pigment. Mixing was done in a stirred 1 L stainless steel mixing vessel using a High Speed Dispersers, (HSD), with a 60 mm Cowels type blade attached to the HSD and operated at 3500 rpm for 2 hours.

The total amount of dispersion prepared for each sample was about 760 grams. The dispersions were often made using a staged procedure in which a fraction of the solvent is held out during milling to achieve optimal viscosity for grinding efficiency. The dispersions made using the Eiger Minimill were processed using a recirculation milling process for a total of 4 hours.

Dispersion 1-8 are based on black pigment Nipex 180 from Avionics, Parsippany N.J., U.S.A. were prepared with the Dispersants 1 to 8. Dispersions 9 and 10 used a TRB-2 Cyan pigment, commercially available from Dainichiseika. The Pigment/Dispersant ratio was 2. All of the pigment dispersions were made in a similar manner. Dispersion Example 10 is described in detail.

### Dispersion Example 10

A 760 gram dispersion sample was prepared by adding the following ingredients, in order, into a 1 Liter stainless steel pot. Each ingredient was added slowly with mixing using a High Speed Disperser operated 1000 rpm with a 60 mm Cowels type blade. The targeted pigment loading in the premix stage was 25%.

| | |
|---|---|
| 1. Deionized water | 81.87 grams |
| 2. KOH (45.4% active solution) | 1.25 grams |
| 3. Polyurethane Dispersant 11 | 191.00 grams |
| 4. Dainichiseika TRB-2 Cyan pigment | 91.38 grams |

After loading the pigment, the High Speed Disperser was increased to 3500 rpm and was ran for 2 hours For this example Polymer Dispersant 11 was neutralized in situ to 60% using KOH and was performed in the premix vessel.

Additional deionized water was added to reduce pigment level in premix to 21.5% prior to milling. Next, the dispersion was processed on the model M250 Eiger Minimill using a recirculation process for 4 hours at a flow rate through the mill of 330 grams per minute.

| | |
|---|---|
| 5. Deionized water | 59.50. grams |

After completing the milling process, the final deionized water letdown was added to achieve the final target pigment loading of 12.0%.

| | |
|---|---|
| 6. Deionized water (final letdown) | 336.45 grams. |

Pigment Dispersion properties are reported in Table 1.

TABLE 1
Pigment Dispersion Properties

| Pigment | | | | vis- | | | |
|---|---|---|---|---|---|---|---|
| Dispersion | | Pig- | | cosity, | | | % |
| Examples | Dispersant | ment | pH | CPS | D50 | D95 | <204 |
| 1 | 7 | K | 7.16 | N/A | 93 | 231 | 92% |
| 2 | 2 | K | 7.15 | N/A | 82 | 196 | 96% |
| 3 | 3 | K | 7.07 | N/A | 95.8 | 252.3 | 91% |
| 4 | 5 | K | 6.97 | N/A | 102 | 285 | 85% |
| 5 | 8 | K | 7.04 | N/A | 98 | 248 | 90% |
| 6 | 1 | K | 6.98 | N/A | 128 | 262 | 88% |
| 7 | 4 | K | 7.06 | N/A | 90.5 | 185.1 | 97% |
| 8 | 6 | K | 7.34 | N/A | 149 | 589 | 71% |
| 9 | 9 | C | 6.25 | 3.49 | 111.1 | 214.1 | |
| 10 | 11 | C | 8.12 | 3.48 | 130.8 | 401 | |
| Comparison | Comparison | K | 7.14 | N/A | 104 | 241 | 90% |
| Dispersion 1 | Dispersant 1 | | | | | | |
| Comparison | Comparison | K | 7.28 | N/A | 80.8 | 163.8 | 99% |
| Dispersion 2 | Dispersant 2 | | | | | | |

### Preparation of Inks

The inks were prepared with pigmented dispersions made using inventive polymers described above by conventional process known to the art. The pigmented dispersions are processed by routine operations suitable for inkjet ink formulation.

Typically, in preparing ink, all ingredients except the pigmented dispersion are first mixed together. After all the other ingredients are mixed, the pigmented dispersion is added. Common ingredients in ink formulations useful in pigmented dispersions include one or more humectants, co-solvent(s), one or more surfactants, a biocide, a pH adjuster, and de-ionized water.

Ink Examples were prepared from the Inventive Dispersants. The Pigment Dispersions listed in Table 1 were used to prepare these inks. The inks were formulated to contain 7% black pigment and the Polyurethane Ink Additive. The comparison ink (Comp A) used Comparison Polyurethane Dispersant 1. The inks were tested by heating them to 70° C. for seven days. Then the ink properties were tested again.

TABLE 2
Inventive Ink Examples: Formulations

| | Ink Examples | | | | | |
|---|---|---|---|---|---|---|
| Ingredients | A | B | C | D | E | Comp A |
| Pigment Disp 7 | X | | | | | |
| Pigment Disp 2 | | X | | | | |
| Pigment Disp 3 | | | X | | | |
| Pigment Disp 5 | | | | X | | |
| Pigment Disp 8 | | | | | X | |
| Comp Disp 1 | | | | | | X |
| Pigment | 7.00% | 7.00% | 7.00% | 7.00% | 7.00% | 7.00% |
| Glycerol | 19.00% | 17.00% | 19.00% | 12.00% | 19.00% | 19.00% |
| Ethylene Glycol | 9.00% | 9.00% | 9.00% | 9.00% | 9.00% | 9.00% |
| Proxel | 0.16% | 0.16% | 0.16% | 0.16% | 0.16% | 0.16% |
| D.I. Water | Balance | Balance | Balance | Balance | Balance | Balance |
| Polyurethane | 7.0% | 7.0% | 7.0% | 5.0% | 7.0% | 7.0% |
| ink additive | | | | | | |
| Surfynol 440 | 1.00% | 1.00% | 1.00% | 1.00% | 1.00% | 1.00% |

TABLE 3
Inventive Ink Examples: Properties

| | Ink Examples; properties | | | | | |
|---|---|---|---|---|---|---|
| | A | B | C | D | E | Comp A |
| pH | 7.70 | 7.80 | 7.72 | 7.89 | 7.90 | 7.83 |
| Surface Tension | 31.62 | 31.58 | 31.57 | 30.73 | 31.75 | 32.43 |
| Conductivity | 0.760 | 0.795 | 0.756 | 0.650 | 0.560 | 0.606 |
| Viscosity | 7.43 cps | 6.57 cps | 7.23 cps | 8.21 cps | 8.07 cps | 7.47 cps |
| (30 rpm/60 rpm@25° C.) | | | | | | |
| 50%/95% | 0.089 | 0.091 | 0.078 | 0.152 | 0.120 | 0.121 |
| % <204.4 nm | 94.18 | 95.09 | 95.74 | 62.44 | 80.11 | 81.47 |
| | Oven Aged 70 C. 7 days | | | | | |
| pH | 7.39 | 7.53 | 7.46 | 7.45 | 7.52 | 7.37 |
| Surface Tension | 32.28 | 32.24 | 32.33 | 32.01 | 32.53 | 33.18 |
| Conductivity | 0.893 | 0.925 | 0.859 | 0.799 | 0.673 | 0.683 |
| Viscosity | 7.62 cps | 10.60 cps | 7.18 cps | EEEE | EEEE | 14.70 cps |
| (30 rpm/60 rpm@25° C.) | | | | | | |
| 50%/95% | 0.080 | 0.121 | 0.091 | 0.213 | 0.214 | 0.184 |
| % <204.4 nm | 95.70 | 74.68 | 92.16 | 48.78 | 48.53 | 55.70 |

EEEE indicates that the viscosity had increased to a level that was outside of the range of the viscosity measurement. Except for the viscosity changes the inks were judged stable after the aging study.

### Printing and Testing Techniques

Inkjet printers used to test the inks were commonly used Hewlett Packard printers for the paper substrates and the following printers for the textile substrates:

(1) a print system with a stationery print head mount with up to 8 print heads, and a media platen. The printheads were from Xaar (Cambridge, United Kingdom). The media platen held the applicable media and traveled underneath the print heads. The sample size was 7.6 cm by 19 cm. Unless otherwise noted this print system was used to print the test samples.

(2) Seiko IP-4010 printer configured to accept fabrics

(3) DuPont® Artistri® 2020 printer.

The fabrics used were obtained from Testfabrics, Inc, (Pittston Pa.) namely: (1) 100% cotton fabric style #419W, which is a bleached, mercerized combed broadcloth (133×72); and (2) Polyester/cotton fabric style #7435M, which is a 65/35 poplin mercerized and bleached.

In some examples, the printed textile was fused at elevated temperature and pressure. Two different fusing apparatus were employed:

(1) a Glenro (Paterson, N.J.) Bondtex™ Fabric and Apparel Fusing Press which moves the printed fabric between two heated belts equipped with adjustable pneumatic press and finally through a nip roller assembly; and

(2) a platen press, assembled for the purpose of precisely controlling temperature and pressure. The platen press was comprised of two parallel 6″ square platens with embedded resistive heating elements that could be set to maintain a desired platen temperature. The platens were fixed in a mutually parallel position to a pneumatic press that could press the platens together at a desired pressure by means of adjustable air pressure. Care was taken to be sure the platens were aligned so as to apply equal pressure across the entire work piece being fused. The effective area of the platen could be reduced, as needed, by inserting a spacer (made, for example from silicone rubber) of appropriate dimensions to allow operation on smaller work pieces.

The standard temperature for the fusing step in the examples was 160° C. unless otherwise indicated.

The printed textiles were tested according to methods developed by the American Association of Textile Chemists and Colorists, (AATCC), Research Triangle Park, N.C. The AATCC Test Method 61-1996, “Colorfastness to Laundering, Home and Commercial: Accelerated”, was used. In that test, colorfastness is described as “the resistance of a material to change in any of its color characteristics, to transfer of its colorant(s) to adjacent materials or both as a result of the exposure of the material to any environment that might be encountered during the processing, testing, storage or use of the material.” Tests 2A and 3A were done and the color washfastness and stain rating were recorded. The rating for these tests were from 1-5 with 5 being the best result, that is, little or no loss of color and little or no transfer of color to another material, respectively.

Colorfastness to crocking was also determined by AATCC Crockmeter Method, AATCC Test Method 8-1996. The ratings for these tests were from 1-5 with 5 being the best result, that is, little or no loss of color and little or no transfer of color to another material, respectively. The results are rounded to the nearest 0.5, which was judged to be accuracy of the method.

Inks A to E and Comparison Ink 1 were printed on cotton and a polyester/cotton blend and tested for OD, wet and dry crock and washfastness.

TABLE 4
Inventive Inks Printed on Textiles

For 419 Cotton Substrate

| | | Dry | Wet | 3A |
|---|---|---|---|---|
| ink | OD | Crock | Crock | wash |
| A | 1.15 | 4.38 | 1.96 | 3.31 |
| B | 1.19 | 4.50 | 2.36 | 3.24 |
| C | 1.18 | 4.60 | 2.08 | 2.50 |
| D | 1.19 | 2.31 | 1.68 | 3.30 |
| E | 1.17 | 4.39 | 2.61 | 3.50 |
| Comp Ink A | 1.20 | 4.45 | 2.25 | 3.50 |

Fused @ 190 C. for 1 minute

| | Fabric #7409 Poly/Cotton Blend | | | |
|---|---|---|---|---|
| | Substrate | | | |
| | | Dry | Wet | 2A |
| ink | OD | Crock | Crock | wash |
| A | 1.04 | 4.61 | 2.37 | 2.64 |
| B | 1.08 | 4.51 | 2.50 | 2.47 |
| C | 1.09 | 4.52 | 2.78 | 2.64 |

Fused @ 170 C. for 2 minute

The inventive inks when printed on cotton and cotton blends were at least comparable to the Comparative Ink A.

1. An aqueous pigment dispersion comprising an aqueous vehicle, a pigment and a first polyurethane dispersant, wherein
(a) the first polyurethane dispersant physically adsorbs to the pigment,
(b) the first polyurethane dispersant stably disperses the pigment in the aqueous vehicle,
(c) the first polyurethane dispersant comprises an alkoxy aromatic diol, a diol substituted with an ionic group, and isocyanate;
wherein the alkoxy aromatic diol is Z₁ 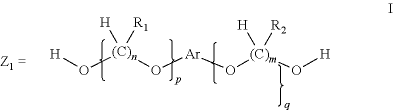
wherein Ar is an aromatic group,
n, m, p, and q are integers,
n, m are the same or different and are greater than or equal to 2 to 12,
p is greater than or equal to 1 to 15,
q is greater than or equal to 0 to 15,
R₁, R₂ are the same or different and each is independently selected from the group consisting of hydrogen, methyl, ethyl and higher alkyls of the formula of CₜH₂ₜ₊₁; where t is an integer and is greater than or equal to 3 to 36.
Z₂ is a diol substituted with an ionic group; and
at least one Z₁ and at least one Z₂ must be present in the first polyurethane dispersant composition; and
wherein the average pigment size of the aqueous pigment dispersion is less than about 300 nm.

2. (canceled)

3. The aqueous pigment dispersion of claim 1, wherein the first polyurethane dispersant has an ionic content of about 10 to 210 milliequivalents per 100 g of polyurethane.

4. The aqueous pigment dispersion of claim 1 where the first polyurethane dispersant has a number average molecular weight of about 2000 to about 30,000.

5. The aqueous pigment dispersion of claim 1 where the first polyurethane dispersant further comprises a nonionic diol.

6. The aqueous pigment dispersion of claim 1 wherein the alkoxy aromatic diol Z₁ p is selected from the group 1, 2, 3 or 4 and q is selected from the group 1, 2, 3 or 4.

7. The aqueous pigment dispersion of claim 1 wherein the aromatic group is a hydroquinone.

8. The aqueous pigment dispersion of claim 1 wherein the aromatic group is a bisphenol.

9. The aqueous pigment dispersion of claim 1, wherein the aqueous vehicle is a mixture of water and at least one water-miscible solvent.

10. An aqueous pigment dispersion comprising a pigment and a second polyurethane dispersant in an aqueous vehicle, wherein:
(a) the second polyurethane dispersant is physically adsorbs to the pigment,
(b) the second polyurethane dispersant stably disperses the pigment in the aqueous vehicle,
(c) the second polyurethane dispersant comprises an alkoxy aromatic diol, a diol substituted with an ionic group, and isocyanate;
wherein the second polyurethane dispersant comprises at least one compound of the structure (II) 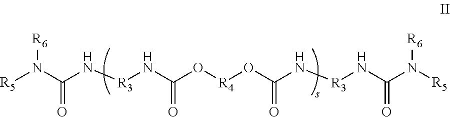
R₃ is alkyl, substituted alkyl, substituted alkyl/aryl from diisocyanate,
R₄ is Z₁ or Z₂,
R₅ is hydrogen; alkyl; branched alkyl or substituted alkyl from the amine terminating group,
R₆ is alkyl, branched alkyl or substituted alkyl from the amine terminating group,
s is an integer is greater than or equal 2 to 30; and
wherein the alkoxy aromatic diol is Z₁ 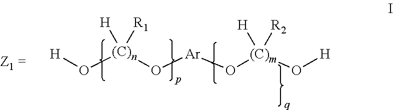
wherein Z₁Ar is an aromatic group,
n, m, p, and q are integers,
n, m are the same or different and are greater than or equal to 2 to 12,
p is greater than or equal to 1 to 15,
q is greater than or equal to 0 to 15,
R₁, R₂ are the same or different and each is independently selected from the group consisting of hydrogen, methyl, ethyl and higher alkyls of the formula of CₜH₂ₜ₊₁; where t is an integer and is greater than or equal to 3 to 36.
Z₂ is a diol substituted with an ionic group; and
wherein the average pigment size of the dispersion is less than about 300 nm.

11. The aqueous pigment dispersion of claim 10 where Groups R₅ and R₆ of the second polyurethane dispersant are substituted with nonionic hydrophilic groups.

12. The aqueous pigment dispersion of claim 10 where Groups R₅ and R₆ of the second polyurethane dispersant are methoxyethyl.

13. The aqueous pigment dispersion of claim 10 where Groups R₅ and R₆ of the second polyurethane dispersant are alkyl.

14. An aqueous colored ink jet ink comprising the aqueous pigment dispersion of claim 10, having from about 0.1 to about 10 wt % pigment based on the total weight of the ink, a weight ratio of the pigment to the second polyurethane dispersant of from about 0.5 to about 6, a surface tension in the range of about 20 dyne/cm to about 70 dyne/cm at 25° C., and a viscosity of lower than about 30 cP at 25° C.

15. The aqueous pigment dispersion of claim 10, wherein the second polyurethane dispersant has an ionic content of about 10 to 210 milliequivalents per 100 g of polyurethane.

16. The aqueous pigment dispersion of claim 10 where the second polyurethane dispersant has a number average molecular weight of about 2000 to about 30,000.

17. The aqueous pigment dispersion of claim 10 where the second polyurethane dispersant further comprises a nonionic diol.

18. The aqueous pigment dispersion of claim 10 wherein the alkoxy aromatic diol Z₁ p is selected from the group 1, 2, 3 or 4 and q is selected from the group 1, 2, 3 or 4.

19. The aqueous pigment dispersion of claim 10 wherein the aromatic group is a hydroquinone.

20. The aqueous pigment dispersion of claim 10 wherein the aromatic group is a bisphenol.

21. The aqueous pigment dispersion of claim 10, wherein the aqueous vehicle is a mixture of water and at least one water-miscible solvent.

22. (canceled)

23. (canceled)

24. (canceled)
